(19) United States
(12) Patent Application Publication
(10) Pub. No.: US 2019/0143261 A1
(43) Pub. Date: May 16, 2019

(54) METHODS FOR INHIBITING SOLVENT EMISSIONS

(71) Applicants: Rachid Mabrouk, Munich (DE); Stevan Jovanovic, North Plainfield, NJ (US); Joseph Naumovitz, Lebanon, NJ (US); Ramachandran Krishnamurthy, Bridgewater, NJ (US)

(72) Inventors: Rachid Mabrouk, Munich (DE); Stevan Jovanovic, North Plainfield, NJ (US); Joseph Naumovitz, Lebanon, NJ (US); Ramachandran Krishnamurthy, Bridgewater, NJ (US)

(21) Appl. No.: 16/248,032

(22) Filed: Jan. 15, 2019

Related U.S. Application Data
(62) Division of application No. 15/297,779, filed on Oct. 19, 2016.

(51) Int. Cl. B01D 53/14

(52) U.S. Cl. CPC B01D 53/1475; Y02A 50/2342; Y02C 10/06; B01D 2258/0283; B01D 2257/302; B01D 2252/204; B01D 53/1425

(57) ABSTRACT

A method for reducing the loss of solvent during carbon dioxide capture from flue gas in an amine based solvent process by the steps of feeding a flue gas containing carbon dioxide to an absorber column containing an amine solvent; absorbing carbon dioxide in the amine solvent forming a rich solvent; feeding the rich solvent to at least one inter-stage cooler; recovering the rich solvent and feeding the rich solvent to a regeneration column; separating the carbon dioxide from the rich solvent and recovering the carbon dioxide to form a lean solvent; feeding the lean solvent to the absorber column. The improvement is realized by one of feeding steam to the flue gas; feeding steam to the absorber column after introduction of amine solvent; feeding the flue gas stream to a demister before feeding to the absorber column or increasing the lean solvent inlet temperature into the absorber column.

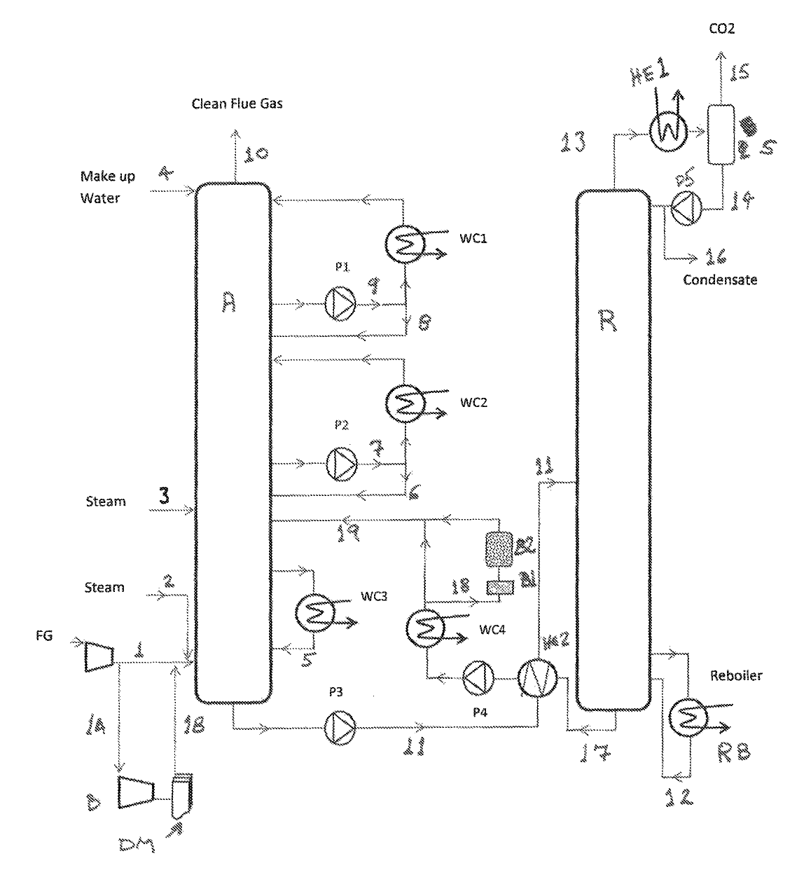

### BACKGROUND OF THE INVENTION

The invention relates to improved methods for inhibiting solvent aerosol emissions from solvent based carbon dioxide capture processes.

In solvent based processes for recovering carbon dioxide from gaseous streams, the carbon dioxide is first absorbed from a gas mixture by contacting the gas mixture with a water solution of amine-based solvent inside an absorber, followed by desorbing the carbon dioxide in a regenerator (a.k.a. stripper) and recirculating the regenerated solvent back to the absorber. The solvents are typically aqueous solutions of amine-based solvents such as MEA, MDEA, OASE®-blue from BASF and KS-1 solvents from MHI. It is known that the absorption process is enhanced by increased pressure and reduced temperature while the regeneration process is favored by reduced pressure and increased solvent temperature. Increased temperature required for the regeneration within the stripper requires significant amount of thermal energy which is typically provided by a condensation of low pressure saturated steam to heat up a reboiler used for boiling a mixture of carbon dioxide and solvent at the bottom of the stripper.

Significant efforts have been made in discovering new solvents which would require less energy for carbon dioxide absorption and would exhibit higher resistance to oxidative and thermal degradation while allowing for more favorable operating conditions resulting in more energy efficient carbon dioxide recovery processes. In order to enhance carbon dioxide absorption, process improvements such as using an absorber intercooler to control the temperature rise of the solvent due to the exothermicity of the carbon dioxide absorption process have been proposed and implemented in commercial plants.

Additionally, few recent post combustion capture process configurations such as positioning a flue gas blower downstream from the absorber are aimed to reduce post combustion capture parasitic load and to consequently increase net power generation efficiency.

The loss of solvent in the form of aerosols from the absorber column will increase cost due to loss of solvent, energy costs and process efficiency. The present invention is directed to methods for reducing this loss of solvent in the form of aerosols.

### SUMMARY OF THE INVENTION

In a first embodiment of the invention, there is disclosed an improved method for reducing aerosol emissions during the carbon dioxide capture from flue gas in an amine based solvent process comprising the steps:
a) Feeding a flue gas containing carbon dioxide to an absorber column wherein the absorber column contains an amine solvent;
b) Absorbing carbon dioxide in the amine solvent forming a rich solvent;
c) Feeding the rich solvent to at least one inter-stage cooler;
d) Recovering the rich solvent and feeding the rich solvent to a regeneration column;
e) Separating the carbon dioxide from the rich solvent and recovering the carbon dioxide and forming a lean solvent;
f) Feeding the lean solvent to the absorber column; the improvement comprising
g) Feeding steam to the flue gas containing carbon dioxide,

In a second embodiment of the invention, there is disclosed an improved method for reducing aerosol emissions during the carbon dioxide capture from flue gas in an amine based solvent process comprising the steps:
a) Feeding a flue gas containing carbon dioxide to an absorber column wherein the absorber column contains an amine solvent;
b) Absorbing carbon dioxide in the amine solvent forming a rich solvent;
c) Feeding the rich solvent to at least one inter-stage cooler;
d) Recovering the rich solvent and feeding the rich solvent to a regeneration column;

e) Separating the carbon dioxide from the rich solvent and recovering the carbon dioxide and forming a lean solvent;
f) Feeding the lean solvent to the absorber column; the improvement comprising
g) Feeding steam to the absorber column after introduction of amine solvent.

In a third embodiment of the invention, there is disclosed an improved method for reducing aerosol emissions during the carbon dioxide capture from flue gas in an amine based solvent process comprising the steps:
a) Feeding a flue gas containing carbon dioxide to an absorber column wherein the absorber column contains an amine solvent;
b) Absorbing carbon dioxide in the amine solvent forming a rich solvent;
c) Feeding the rich solvent to at least one inter-stage cooler;
d) Recovering the rich solvent and feeding the rich solvent to a regeneration column;
e) Separating the carbon dioxide from the rich solvent and recovering the carbon dioxide and forming a lean solvent;
f) Feeding the lean solvent to the absorber column; the improvement comprising
g) Feeding the flue gas stream to a demister before the flue gas stream enters the absorber column.

In a fourth embodiment of the invention, there is disclosed an improved method for reducing aerosol emissions during the carbon dioxide capture from flue gas in an amine based solvent process comprising the steps:
a) Feeding a flue gas containing carbon dioxide to an absorber column wherein the absorber column contains an amine solvent;
b) Absorbing carbon dioxide in the amine solvent forming a rich solvent;
c) Feeding the rich solvent to at least one inter-stage cooler;
d) Recovering the rich solvent and feeding the rich solvent to a regeneration column;
e) Separating the carbon dioxide from the rich solvent and recovering the carbon dioxide and forming a lean solvent;
f) Feeding the lean solvent to the absorber column; the improvement comprising
g) Increasing the amine solvent inlet temperature.

The flue gas contains 2 to 15% carbon dioxide.

The absorber column comprises a solvent absorption section and a water wash section.

The at least one inter-stage cooler is three inter-stage coolers.

The regeneration column further comprises a reboiler and may further comprise a separator bed.

The lean solvent passes through a particulate filter and active carbon bed before entering the absorber column.

### BRIEF DESCRIPTION OF THE DRAWINGS

The FIGURE is a schematic of a facility for the carbon dioxide capture from a flue gas stream using amine based solvents.

### DETAILED DESCRIPTION OF THE INVENTION

The FIGURE is a schematic of a system for separating carbon dioxide from a flue gas stream using an amine solvent. This process uses two columns, an absorber column and a desorption or regeneration column, A and R respectively. The absorber column A consists of two sections, the solvent absorption section at the bottom of column A and the water wash section at the top of the column A.

A flue gas stream or other gas stream containing carbon dioxide is fed through line 1 into absorber column A. Typically this gas stream contains 2 to 15% carbon dioxide. The carbon dioxide will be absorbed in the liquid solvent which flows in a counter current mode in the column A. The liquid solvent is typically an amine solvent. The gas stream which is now depleted of carbon dioxide will continue through the wash section where make-up water is introduced into column A through line 4 where solvent carry over and traces of solvent are washed from the gas stream before leaving absorber column A as clean treated gas through line 10.

The carbon dioxide absorption in the liquid solvent is an exothermic reaction hence the temperature within the absorber column will increase. To maintain the temperature of the absorber column within acceptable limits typically less than 90° C., and to enhance the carbon dioxide kinetic absorption, the solvent must be cooled. This cooling is accomplished by feeding the solvent to an inter-stage cooler WC3. The solvent will be fed through line 5 to the inter-stage cooler WC3 where it will be reduced in temperature 10° to 20° C. before reentering the absorber column A.

Two additional inter-stage coolers are also present in conjunction with absorber column A. The solvent is fed through line 7 to pump P2 before entering inter-stage cooler WC2. Part of the solvent is fed back through line 6 to absorber column A while the portion that passes through the inter-stage cooler WC2 is fed through line 7 back to the absorber column A with cooler solvent. Likewise and further up the absorber column A, some solvent is removed and fed through line 9 to pump P1 where a portion is returned through line 8 to the absorber column A. The other portion is fed through the inter-stage cooler WC1 where cooler solvent is returned to the top stage of the absorber column A through line 9.

In certain embodiments of the invention, two inter-stage coolers can be employed.

The solvent that is loaded with absorbed carbon dioxide is typically referred to as a rich solvent and this is pumped from absorber column A by pump P3 through line 11 to the regeneration or desorption column R. The carbon dioxide in the solvent is stripped from the rich solvent and the resultant solvent is referred to as lean solvent. Typically, the regeneration column R operates at 120° to 130° C. and pressures of 1 to 5 bar.

A reboiler RB is installed at the bottom of the regeneration column R where a portion of the rich solvent is removed through line 12 and heated, typically by low pressure steam in the reboiler RB before being fed back into the regeneration column R.

The carbon dioxide gas is released from the rich solvent and will exit the regeneration column R through line 13 where it passes through heat exchanger HE1 where it will be cooled down in temperature. The cooler carbon dioxide is fed from heat exchanger HE1 to a separator S where other molecules that are carried out of the regeneration column R mainly water condensate are separated from the cooler carbon dioxide. The carbon dioxide is thus recovered from separator S through line 15 while the separated components are fed through line 14 to pump P5 where they are returned to the regeneration column R. The water condensate will be separated through line 16.

The lean solvent stream will exit the regeneration column from the bottom through line 17. The lean solvent stream is first cooled in heat exchanger HE2 where the heat removed is transferred through heat exchanger HE2 to the rich solvent stream entering the regeneration column R through line 11. The now cooler lean solvent stream is fed through line 17 and pump P4 to a further inter-stage cooler WC4. The further cooled lean solvent stream may be fed through line 17 to line 19 where it will enter the absorber column A. The regeneration temperature for the OASE®-blue may be for example in the range of 100° to 120° C.

The amine solvents that are employed are typical of amine based solvents, differing in their resistance to oxidation from oxygen carried with the flue gas and the solvent regeneration duty required.

In the event that any particulates are present in the lean solvent, it will be fed through line 19 to a particulate filter B1 and active carbon bed B2 where the particulates are removed. This particulate-free lean solvent stream will be fed through line 19 for entry into the absorber column A.

The present invention will manage aerosol emissions as well as reducing solvent loss by several techniques. In the first embodiment, steam is fed through line 2 into the flue gas stream containing carbon dioxide as it enters the absorber column A. The steam will condense on the submicron particles which will increase their density and size. The fine particles will increase in size and density until the gravity force becomes predominant and the particles fall into the solvent bulk. Further, when the flue gas stream is also high in SO₃ content, steam injection will convert the SO₃ in sulfuric acid droplets that can be condensed downstream in the absorber column A. The amount of steam is dictated by a delta approach to dew point. It is preferred to add low grade steam (LP steam of 4 to 8 bara) while keeping within the 10° C. approach to dew point.

With respect to the sulfuric acid, the amount produced is typically small and in the parts per million level. However, if an upstream washing system is bypassed then the amount of sulfuric acid produced could be in the thousands of ppm levels.

In a second embodiment of the invention, steam can be fed through line 3 to the absorber column A. This feed point is at a point in the absorber column A above the lean solvent inlet nozzle, in this case, line 19. By the same mechanism as in the first embodiment, the steam can condense on the submicron particles increasing their size for handling. The second inlet stream above the lean solvent inlet stream is to catch any fine particles that might be carried out while the lean solvent passes through the carbon filter or any dust from equipment corrosion.

In a third embodiment, the flue gas stream that is fed via line 1 into the absorber column A is diverted through line 1A where it will enter a demister DM. Typically this demister is submicron and Brownian type where the fine particulate is captured before the flue gas stream is fed through line 1B back to line 1 for entry into the absorber column A. Due to additional pressure drop, a blower or steam ejector B may be required for feeding the flue gas stream into the demister DM. A Brownian demister will typically operate like other demisters with smaller opening area for gas acting as a filter. The pressure drop in this case can be quite significant which leads to an increase in the head pressure. A steam ejector could be employed if enough steam is available.

In a fourth embodiment of the invention, reducing the temperature differential between the lean solvent inlet temperature at line 19 into column A and the immediate absorption section above the lean solvent inlet line 19 will reduce solvent aerosol emissions. Accordingly, the temperature of the lean solvent at its inlet is 50° to 55° C. due to the absorption heat when the carbon dioxide is absorbed in the lean solvent. Preferably, the lean solvent thus fed at these elevated temperatures can bypass the second stage inter-stage cooler WC2 as it flows upwards through the absorber column A. This results in the third inter-stage cooler not being necessary.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

1. An improved method for reducing aerosol emissions during the carbon dioxide capture from flue gas in an amine based solvent process comprising the steps:
a) Feeding a flue gas containing carbon dioxide to an absorber column wherein the absorber column contains an amine solvent;
b) Absorbing carbon dioxide in the amine solvent forming a rich solvent;
c) Feeding the rich solvent to at least one inter-stage cooler;
d) Recovering the rich solvent and feeding the rich solvent to a regeneration column;
e) Separating the carbon dioxide from the rich solvent and recovering the carbon dioxide and forming a lean solvent;
f) Feeding the lean solvent to the absorber column; the improvement comprising
g) Feeding steam to the flue gas containing carbon dioxide.

2. The method as claimed in claim 1 wherein the flue gas contains 2 to 15% carbon dioxide.

3. The method as claimed in claim 1 wherein the absorber column comprises a solvent absorption section and a water wash section.

4. The method as claimed in claim 1 wherein the at least one inter-stage cooler is three inter-stage coolers.

5. The method as claimed in claim 1 wherein the regeneration column further comprises a reboiler.

6. The method as claimed in claim 1 wherein the regeneration column further comprises a separator bed.

7. The method as claimed in claim 1 wherein the lean solvent passes through a particulate filter and active carbon bed before entering the absorber column.

8. (canceled)

9. The method as claimed in claim 1 wherein the flue gas contains 2 to 15% carbon dioxide.

10 to 28. (canceled)
